(19) United States
(12) Patent Application Publication
(10) Pub. No.: US 2015/0084323 A1
(43) Pub. Date: Mar. 26, 2015

(54) MOTOR VEHICLE SAFETY BELT

(71) Applicant: KYUNGPOOK NATIONAL UNIVERSITY INDUSTRY-ACADEMIC COOPERATION FOUNDATION, Daegu (KR)

(72) Inventors: Dong Seog Han, Daegu (KR); In Suk Hamm, Daegu (KR); Kwang Hee Lee, Daegu (KR)

(21) Appl. No.: 14/396,745

(22) PCT Filed: Apr. 18, 2013
(86) PCT No.: PCT/KR2013/003304

§ 371 Date: Oct. 24, 2014

(30) Foreign Application Priority Data
Apr. 24, 2012 (KR) 10-2012-0042670

(51) Int. Cl. B60R 22/14; B60R 22/34

(52) U.S. Cl. CPC B60R 22/14; B60R 22/34; B60R 2022/1818
USPC 280/807

(57) ABSTRACT

Disclosed is a motor vehicle safety belt including: a belt which includes a shoulder belt, and a waist belt, and restricts a body of an occupant; a retractor which is installed at a door side of a vehicle body, and winds up at one end of the belt; a tongue plate which is fastened to the belt; a buckle which is installed at one side of a seat, in which the occupant is seated, fixes the belt, and binds with the tongue plate; and an anchor which fixes the other end of the belt to the vehicle body, in which a belt strap is added at a side opposite to a vertex where the shoulder belt and the waist belt are coupled, so as to form a Δ shape between the shoulder belt and the waist belt.

### TECHNICAL FIELD

The present invention relates to a motor vehicle safety belt, and more particularly, to a motor vehicle safety belt which is configured to allow a shoulder belt to be distant from a neck portion of an occupant when a body of the occupant leans toward a side due to a traffic accident, thereby preventing an accident in which the shoulder belt strikes the neck portion.

### BACKGROUND ART

In general, the greatest reason why a traffic accident such as a collision accident or a rollover accident of a vehicle causes injuries to occupants is that the occupant is catapulted out of the vehicle due to inertia caused by a traveling speed of the vehicle and then falls onto a road surface while experiencing impact, or a driver collides with a front glass, an instrument panel, or the like and then suffers a head injury or a neck injury, or a chest of the driver collides with a steering wheel such that the driver suffers a chest injury.

Thus, although a motor vehicle safety belt does not directly or fundamentally prevent a traffic accident, the motor vehicle safety belt is used as an effective means that fixes the occupant to the seat at the time of a traffic accident, and prevents the occupant from being catapulted out of the vehicle or colliding with apparatuses in the vehicle, thereby reducing a fatality rate and severity of an injury at the time of a traffic accident occurring while the vehicle is travelling, and as a result, traffic regulations make it mandatory for the occupant to fasten the safety belt.

In this case, the motor vehicle safety belt should not cause any inconvenience when the driver drives the vehicle, and needs to surely protect the occupant at the time of an emergency.

As illustrated in FIG. 1, the motor vehicle safety belt typically includes a belt 10 which restricts a body of an occupant, a slip guide 19 which guides the belt 10, a retractor 12 which winds up the belt 10 passing through the slip guide 19, a tongue plate 14 which is fastened to the belt 10, a buckle 16 which fixes the belt 10 and binds with the tongue plate 14 fixed to the belt 10, and an anchor 18 which is a supporting shaft of the belt 10, and in this case, the belt 10 includes a shoulder belt 10a, and a waist belt 10b for the occupant.

It is obvious that the motor vehicle safety belt in the related art as described above exhibits a significant effect in respect that the motor vehicle safety belt reduces injuries to the occupants at the time of a vehicle accident.

That is, severity of an injury to the occupant is relatively reduced when the occupant fastens the safety belt in comparison with when the occupant does not fasten the safety belt, but even though the occupant fastens the safety belt, the occupant may suffer injuries to the neck, the abdomen, the chest, the waist, and the like.

In particular, regarding the structure of the safety belt, the belt has the shoulder belt, and the waist belt, such that the shoulder belt supports an upper body of the occupant and the waist belt supports a pelvis of the occupant at the time of a collision accident, but there is a problem in that in a case in which the body of the occupant leans toward a side due to a traffic accident, the safety belt strikes the neck among other things, which directly and seriously affects the life of the occupant.

### DISCLOSURE

### Technical Problem

The present invention has been made in an effort to solve the aforementioned problem, and an object of the present invention is to provide a motor vehicle safety belt which is configured to allow a shoulder belt to be distant from a neck portion of an occupant when a body of the occupant leans toward a side due to a traffic accident, thereby preventing an accident in which the shoulder belt strikes the neck portion.

### Technical Solution

In order to achieve the aforementioned object, according to an exemplary embodiment of the present invention, there is provided a motor vehicle safety belt including: a belt which includes a shoulder belt, and a waist belt, and restricts a body of an occupant; a retractor which is installed at a door side of a vehicle body, and winds up one end of the belt; a tongue plate which is fastened to the belt; a buckle which is installed at one side of a seat, in which the occupant is seated, fixes the belt, and binds with the tongue plate; and an anchor which fixes the other end of the belt to the vehicle body, in which a belt strap is added at a side opposite to a vertex where the shoulder belt and the waist belt are coupled, so as to form a Δ shape between the shoulder belt and the waist belt.

In addition, any one of one end of the shoulder belt coupled to the belt strap and one end of the waist belt coupled to the belt strap may be configured with an attachment configuration using a Velcro tape.

In addition, both one end of the shoulder belt coupled to the belt strap and the other end of the waist belt coupled to the belt strap may be configured with attachment configurations using a Velcro tape.

In addition, installation positions of the anchor and the retractor may be switched, and the belt having the Δ shape may be wound by the retractor.

According to another exemplary embodiment of the present invention, there is provided a motor vehicle safety belt including: a belt which restricts a body of an occupant; a retractor which winds up one end of the belt; a tongue plate which is fastened to the other end of the belt; a buckle which is installed at one side of a seat in which the occupant is seated, fixes the belt, and binds with the tongue plate fixed to the belt; an anchor which fixes the other end of the belt to a vehicle body; and a slip guide which is fixed at one side of a shoulder portion of a seat backrest by a fixing means, in which the retractor is installed at a rear side of the seat backrest, and the belt is guided to the retractor by the slip guide.

In addition, an installation hole having a predetermined depth may be formed at the rear side of the seat backrest, the retractor may be installed in the installation hole, a hinge shaft may be provided at an upper end inside the installation hole, and the retractor may be rotatably fastened and fixed to the hinge shaft.

In addition, the motor vehicle safety belt may include a movement prevention member which is fixed to the hinge shaft, and prevents the retractor from being moved leftward and rightward on the hinge shaft.

In addition, the motor vehicle safety belt may include a guide groove which is formed in a diagonal direction, which is symmetric with a direction in which the belt surrounds the occupant, so as to be associated with the installation hole, and guides the belt, which is withdrawn from the retractor, to the slip guide.

In addition, the motor vehicle safety belt may include a cover member which covers the rear side of the seat backrest, and covers the installation hole and the guide groove.

In addition, the belt may have a shock absorbing member.

According to yet another exemplary embodiment of the present invention, there is provided a motor vehicle safety belt including: a belt which restricts a body of an occupant; a retractor which is disposed at a door side of a vehicle body in a vehicle, and winds up one end of the belt; a tongue plate which is fastened to the other end of the belt; a buckle which is installed at one side of a seat in which the occupant is seated, fixes the belt, and binds with the tongue plate fixed to the belt; an anchor which fixes the other end of the belt to a vehicle body; a first slip guide which is fixed at one side of a shoulder portion of a seat backrest by a fixing means; and a second slip guide which is positioned above the first slip guide, and installed on the door side of the vehicle body, in which the belt is guided to the retractor by the first slip guide and the second slip guide.

In addition, the belt may have a shock absorbing member.

### Advantageous Effects

The motor vehicle safety belt according to the present invention is configured to allow the belt to maintain the Δ shape when the tongue plate and the buckle of the safety belt are coupled, and allow the shoulder belt to be distant from the neck portion, thereby preventing the safety belt from striking the neck in a case in which the body of the occupant leans toward a side due to a traffic accident.

In addition, the shoulder belt is fixed at the position of the shoulder portion of the seat backrest by the slip guide, such that the shoulder belt keeps a predetermined distance from the neck portion of the occupant, and is distant from the neck portion of the occupant, thereby eliminating the possibility that the shoulder belt may strike the neck portion.

In addition, the first slip guide is installed at the position of the shoulder portion of the seat backrest such that the belt keeps a predetermined distance from the neck portion of the occupant, and by a process of winding the belt with two steps through the second slip guide, injuries to the neck portion due to the safety belt may be prevented, and driving convenience for the occupant may be achieved.

### DESCRIPTION OF DRAWINGS

FIG. 1 is a view illustrating a motor vehicle safety belt in the related art.

FIGS. 2A to 2C are views illustrating a motor vehicle safety belt according a first exemplary embodiment of the present invention.

FIG. 3 is a perspective view illustrating a motor vehicle safety belt according to a second exemplary embodiment of the present invention.

FIGS. 4A and 4B are exploded perspective views illustrating the motor vehicle safety belt according to the second exemplary embodiment of the present invention.

FIGS. 5A and 5B are views illustrating a slip guide of the motor vehicle safety belt according to the second exemplary embodiment of the present invention.

FIG. 6 is a perspective view illustrating a motor vehicle safety belt according to a third exemplary embodiment of the present invention.

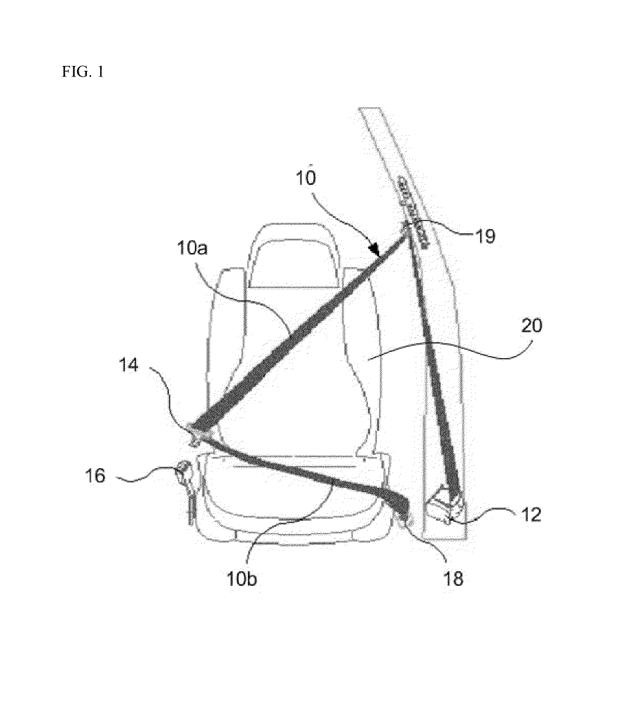

### BEST MODE

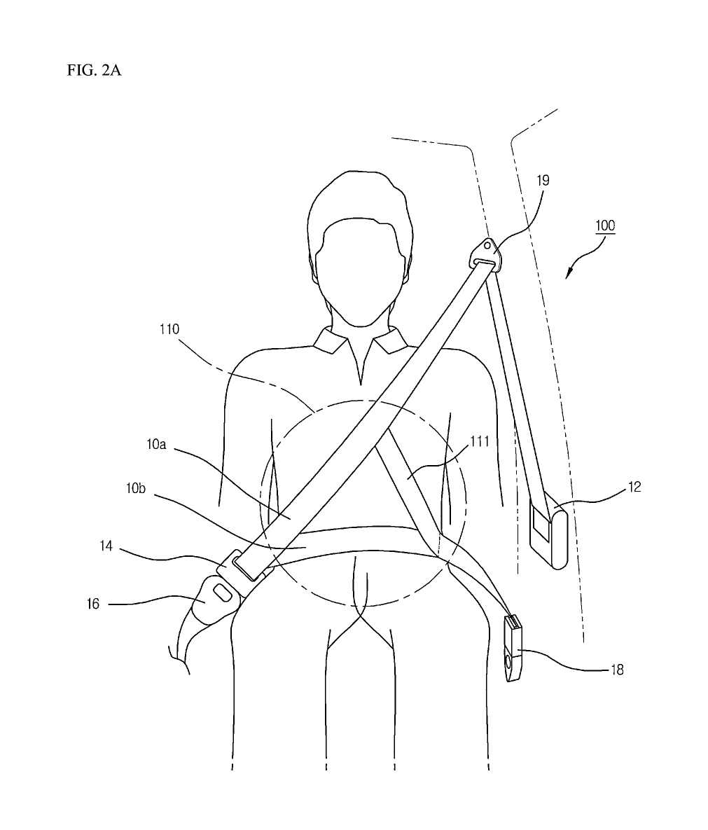

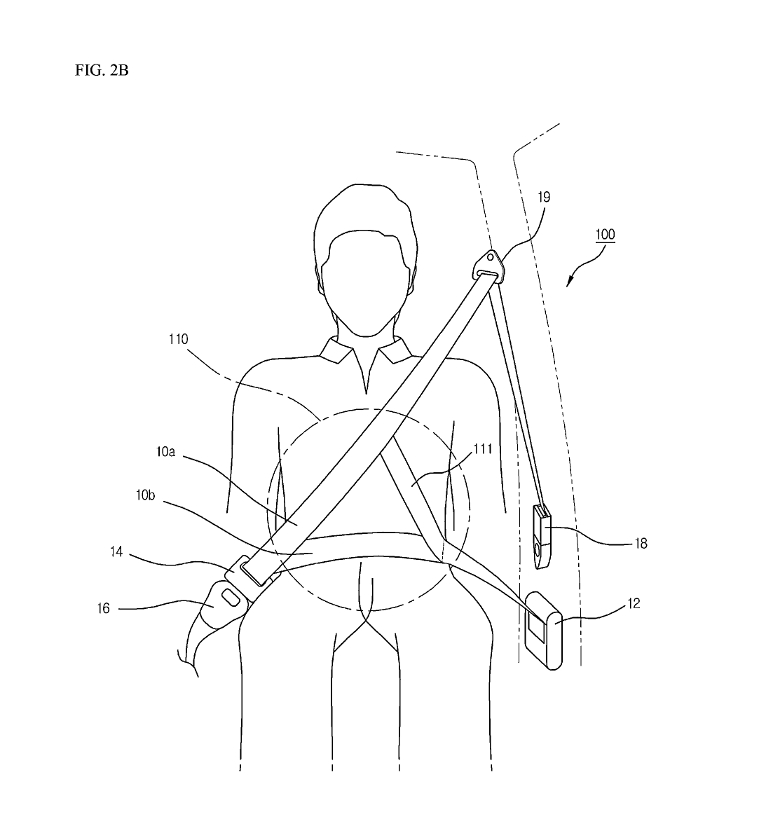

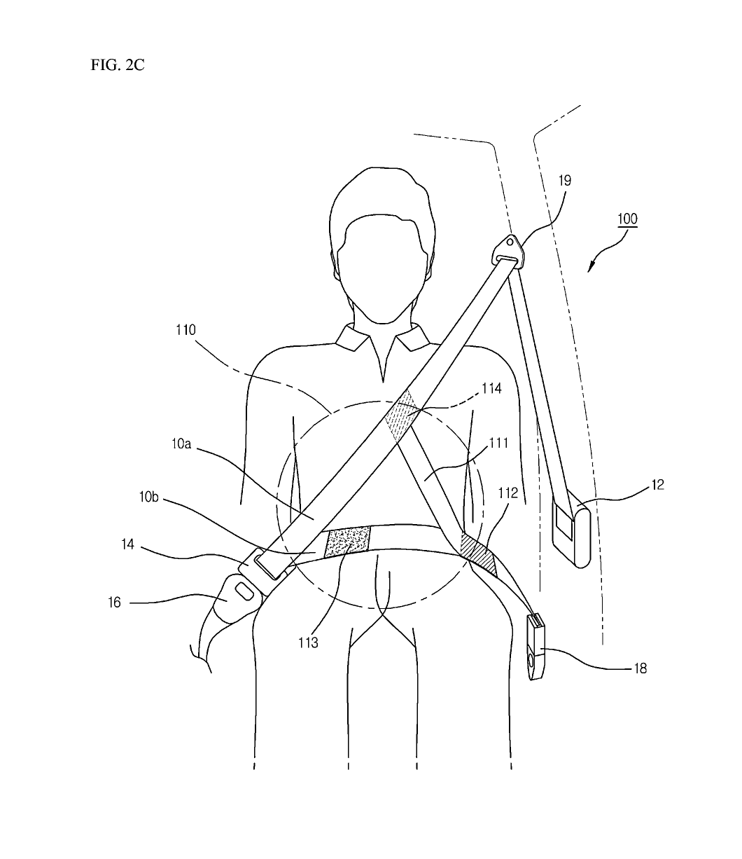

FIGS. 2A to 2C are views illustrating a motor vehicle safety belt 100 according a first exemplary embodiment of the present invention.

As illustrated in FIG. 2A, the motor vehicle safety belt 100 according to the first exemplary embodiment of the present invention includes a belt 110 which restricts a body of an occupant, a retractor 12 which is installed at a door side of a vehicle body in a vehicle and winds up one end of the belt 110, a tongue plate 14 which is fastened to the belt 110, a buckle 16 which is installed at one side of a seat to fix the belt 110 and binds with the tongue plate 14 fixed to the belt 110, and an anchor 18 which fixes the other end of the belt 110 to the vehicle body.

In particular, the motor vehicle safety belt 100 according to the first exemplary embodiment of the present invention is characterized in that in the safety belt in the related art, which includes a shoulder belt 10a, and a waist belt 10b, a belt strap 111 is added to a side opposite to a vertex where the shoulder belt 10a and the waist belt 10b are coupled, as illustrated by a circular dotted line in FIG. 2A, thereby configuring the belt 110 having a Δ shape between the shoulder belt and the waist belt. In this case, portions to which the belt strap 111 is coupled need to be installed at positions where the belt strap 111 may maintain the Δ shape of the belt 110 and may maximally maintain a tense state of the belt 110 when the tongue plate 14 is coupled to the buckle 16. With the aforementioned configuration, the shoulder belt 10a may be maximally distant from a neck portion of the occupant.

### MODE FOR INVENTION

Hereinafter, exemplary embodiments of the present invention will be described in detail with reference to the accompanying drawings.

Constituent elements identical to constituent elements of a motor vehicle safety belt in the related art will be indicated by the same reference numerals

FIGS. 2A to 2C are views illustrating a motor vehicle safety belt 100 according a first exemplary embodiment of the present invention.

As illustrated in FIG. 2A, the motor vehicle safety belt 100 according to the first exemplary embodiment of the present invention includes a belt 110 which restricts a body of an occupant, a retractor 12 which is installed at a door side of a vehicle body in a vehicle and winds up one end of the belt 110, a tongue plate 14 which is fastened to the belt 110, a buckle 16 which is installed at one side of a seat to fix the belt 110 and binds with the tongue plate 14 fixed to the belt 110, and an anchor 18 which fixes the other end of the belt 110 to the vehicle body.

In particular, the motor vehicle safety belt 100 according to the first exemplary embodiment of the present invention is characterized in that in the safety belt in the related art, which includes a shoulder belt 10a, and a waist belt 10b, a belt strap 111 is added to a side opposite to a vertex where the shoulder belt 10a and the waist belt 10b are coupled, as illustrated by a circular dotted line in FIG. 2A, thereby configuring the belt 110 having a Δ shape between the shoulder belt and the waist belt. In this case, portions to which the belt strap 111 is coupled need to be installed at positions where the belt strap 111 may maintain the Δ shape of the belt 110 and may maximally maintain a tense state of the belt 110 when the tongue plate 14 is coupled to the buckle 16. With the aforementioned configuration, the shoulder belt 10a may be maximally distant from a neck portion of the occupant.

Meanwhile, regarding the belt 110 having the Δ shape, in a case in which the Δ shape is formed by the belt strap 111, it may not be easy to allow the belt to pass through the slip guide 19 when the belt is wound by the retractor 12.

As illustrated in FIG. 2B, the retractor 12 and the anchor 18 may be installed so that positions of the retractor 12 and the anchor 18 of the motor vehicle safety belt 100 according to the first exemplary embodiment of the present invention illustrated in FIG. 2A may be switched, thereby allowing the belt to be wound at the waist belt 10b side by the retractor 12. As described above, by changing the position of the retractor 12, the belt 110 having the Δ shape is wound at a lower position of the seat by the retractor 12 instead of being wound at the existing position at the door side of the vehicle body, and as a result, there is no interruption when the belt 110 having the Δ shape passes through the slip guide 19. In addition, the belt 110 having the Δ shape may be quickly and easily wound without enlarging a belt passing hole in the slip guide 19.

As illustrated in FIG. 2C, in the motor vehicle safety belt 100 according to the first exemplary embodiment of the present invention, both ends 112 and 114 of the belt strap 111, which is connected to form the belt 110 having the Δ shape, may be coupled to the shoulder belt 10a or the waist belt 10b by an attachment configuration using a Velcro™ tape that is also called a “loop-and-hook fastener”. In this case, even in a case in which the retractor 12 is installed at the position at the door side of the vehicle body as illustrated in FIG. 2A, both the ends 112 and 114 of the belt strap 111 all have the Velcro tape shape, and as a result, the shoulder belt 10a may be easily wound by the retractor 12 after detaching the belt strap 111. That is, because the belt 110 has the Δ shape, it may not be easy to allow the belt 110 to pass through the slip guide 19 when the belt 110 is wound by the retractor 12, and as a result, after all of the Velcro tapes attached to the shoulder belt 10a and the waist belt 10b are detached, the belt 110 may be easily wound by the retractor 12.

In addition, in a case in which one end of the belt strap 111 attached to the waist belt 10b is maintained as it is, and the other end of the belt strap 111, which has been detached from the shoulder belt 10a, is attached to another predetermined portion 113 of the waist belt 10b, the belt may be easily wound by the retractor 12 for the belt strap 111 without completely detaching the belt strap 111. In this case, since the belt 110 to which the belt strap 111 is coupled has a thickness including a thickness of the belt strap, a belt guide hole of the slip guide 19 is configured to be slightly larger than a belt guide hole of the existing slip guide.

In another exemplary embodiment, the attachment configurations using the Velcro tape are not formed at both the ends of the belt strap 111 that is connected to form the belt 110 having the Δ shape, but the attachment configuration using the Velcro tape may be formed only at one end 114 of the shoulder belt 10a, or only at one end 112 of the waist belt. That is, in a case in which the Velcro tape indicated by reference numeral 112 in FIG. 2C is eliminated, and this portion is integrally coupled, the Velcro tape may be attached to the portion 114 of the shoulder belt 10a when the belt is fastened, and may be attached and coupled to the portion 113 of the waist belt 10b when the belt is released. On the contrary, in a case in which the Velcro tape indicated by reference numeral 114 in FIG. 2C is eliminated, the Velcro tape may be attached to the portion 112 of the waist belt 10b when the belt is fastened, and may be attached and coupled to a portion (not illustrated) of the shoulder belt 10a when the belt is released.

As described above, the belt strap 111, which has been detached from the shoulder belt 10a, is attached to the predetermined portion 113 of the waist belt 10b, or the belt strap 111, which has been detached from the waist belt 10b, is attached to the predetermined portion (not illustrated) of the shoulder belt 10a, such that the belt may be easily wound by the retractor 12. In this case, the belt guide hole of the slip guide 19 through which the belt, to which the belt strap 111 is coupled, passes may be maintained to have a thickness slightly larger than that of the existing slip guide. In addition, in order to maintain the belt guide hole of the slip guide 19 like the existing slip guide, the retractor 12 and the anchor 18 are installed so that the positions of the retractor 12 and the anchor 18 are switched, as illustrated in FIG. 2B, thereby allowing the belt to be wound at the waist belt 10b side by the retractor 12.

Even in this case, the portions to which the belt strap 111 is coupled also need to be installed at positions where the belt strap 111 may maximally maintain a tense state of the belt strap 111 so as to maintain the Δ shape when the tongue plate 14 is coupled to the buckle 16. With the aforementioned configuration, the shoulder belt 10a may be maximally distant from the neck portion of the occupant.

As described above, the belt strap may be easily detached, attached, and separated using the so-called “loop-and-hook fastener”. With the aforementioned configuration, the existing shoulder belt may be distant from the neck portion, thereby preventing injuries to the neck portion.

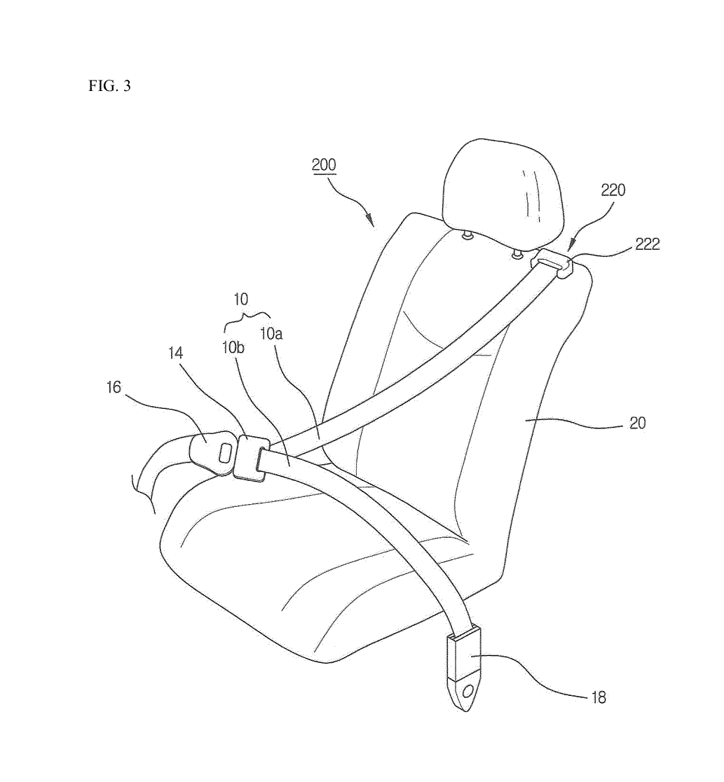

FIG. 3 is a view illustrating a motor vehicle safety belt 200 according to a second exemplary embodiment of the present invention.

As illustrated in FIG. 3, the motor vehicle safety belt 200 according to the second exemplary embodiment of the present invention includes a belt 10 which restricts a body of an occupant, a retractor 12 which is installed at a rear side of a seat backrest 20 and winds up one end of the belt 10, a tongue plate 14 which is fastened to the other end of the belt 10, a buckle 16 which is installed at one side of a seat to fix the belt 10 and binds with the tongue plate 14 fixed to the belt 10, and an anchor 18 which fixes the other end of the belt 110 to a vehicle body.

In particular, when describing a difference from the related art, the retractor 12 is installed at the rear side of the seat backrest 20, and winds up one end of the belt 10 through a slip guide 220 that guides the belt 10.

In addition, the slip guide 220 is fixed to one side of a shoulder portion of the seat backrest 20 by a fixing means, and has a case 222 in which a hole is formed, and the belt 10 is guided by the hole, and wound by the retractor 12.

Since a shoulder belt 10a is fixed at the position of the shoulder portion of the seat backrest 20 by the slip guide 220 as described above, the shoulder belt keeps a predetermined distance from a neck portion of the occupant and is distant from the neck portion and as a result, there is no possibility that the shoulder belt 10a will strike the neck portion.

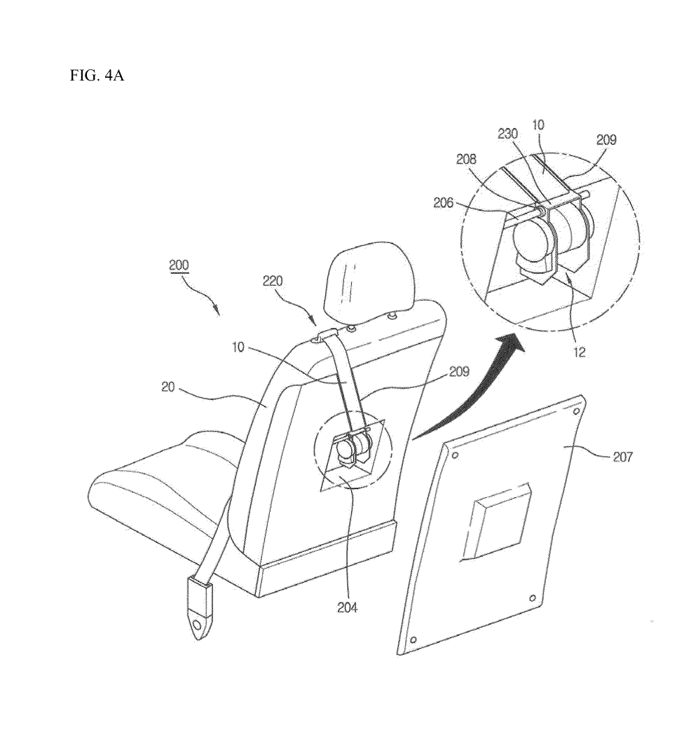

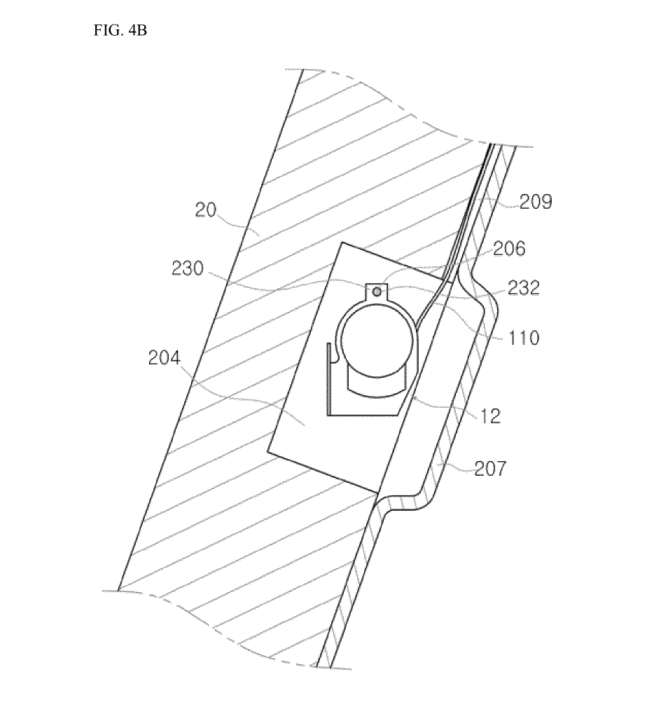

FIG. 4A is an exploded perspective view illustrating the motor vehicle safety belt according to the second exemplary embodiment of the present invention, and FIG. 4B is a cross-sectional view illustrating a state in which the retractor of the motor vehicle safety belt according to the second exemplary embodiment of the present invention is installed.

As illustrated in FIGS. 4A and 4B, an installation hole 204 having a predetermined depth is formed in a central portion at the rear side of the seat backrest 20, and the retractor 12 is installed in the installation hole 204.

That is, a hinge shaft 206 is provided at an upper end inside the installation hole 204, the retractor 12 is rotatably fastened and fixed to the hinge shaft 206, a fixture 230, which has a through hole 232 into which the hinge shaft 206 is fitted, is formed at an upper end portion of the retractor 12, and the hinge shaft 206 is fitted into the through hole 232 formed in the fixture 230, such that the retractor 12 is rotatably fastened and fixed.

In this case, movement prevention portions 208, which are fixed to the hinge shaft 206 and prevents the retractor 12 from being moved leftward and rightward on the hinge shaft 206, are provided at both sides of the fixture 230. In particular, since there is concern that the retractor, which is positioned at the central portion at the rear side of the seat backrest, may be damaged by strong force when a driver fastens and releases the belt, the movement prevention portions 208 need to have strong coupling force like a fastening configuration using adhesion or bolts.

In addition, even in a case in which an angle of the seat backrest 20 is adjusted based on the occupant's demand, the retractor 12 is rotated about the hinge shaft 206, such that the retractor 12 is always maintained in a horizontal state.

For example, when the occupant puts the seat backrest 20 back in order to adjust an inclination angle of the seat backrest 20, the retractor 12 is rotated about the hinge shaft 206 and always maintained in a horizontal state, such that the belt 10 may be safely withdrawn from the retractor 12.

In addition, a guide groove 209, which guides the belt 10 so that the belt 10 may be wound by the retractor 12, is formed at the rear side of the seat backrest 20, and the guide groove 209 is formed in a diagonal direction that is symmetric with a direction in which the belt 10 surrounds the occupant, such that the belt 10 may be easily wound by the retractor 12 installed in the installation hole 204.

In addition, a retractor cover 207, which covers the retractor 12, is installed at the rear side of the seat backrest 20, and the retractor cover 207 may be formed on the seat backrest 20 by means of a bolt-nut configuration or a groove-projection configuration while covering the guide groove 209 as well as the retractor 12 installed in the installation hole 204.

Meanwhile, the shoulder belt 10a is withdrawn from the retractor 12 and positioned in the diagonal direction of the seat backrest 20, and the waist belt 10b is fixed to the anchor 18 formed at one side below the seat. With the aforementioned configuration, the belt 10 is withdrawn from the retractor 12 and surrounds the chest in the diagonal direction of the seat backrest 20.

Since the belt 10 is positioned in the diagonal direction of the seat backrest 20 as described above, the belt 10 may be supported by the slip guide 220 formed on the shoulder portion of the seat backrest 20, such that the driver may drive the vehicle in a state in which the belt 10 keeps a predetermined distance from the neck portion.

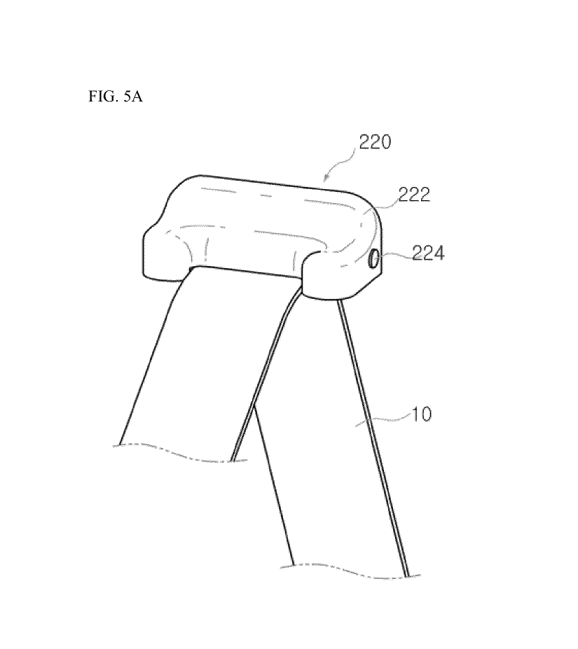

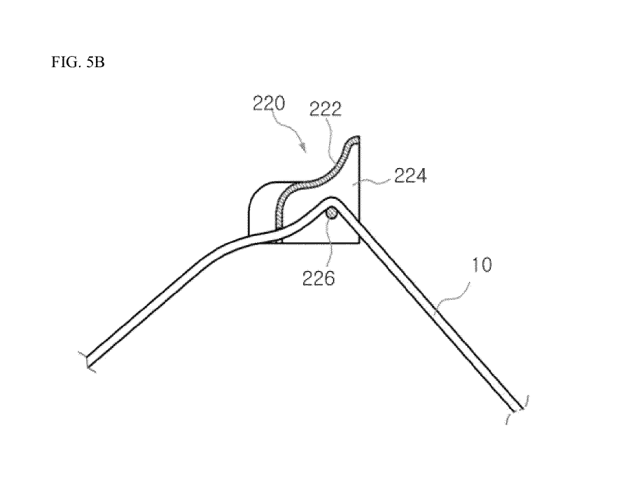

Further, as illustrated in FIGS. 5A and 5B, the slip guide 220, which is formed on the shoulder portion at one side of the upper end portion of the seat backrest 20, serves as a bridge which allows the tongue plate and the buckle to be fastened at a front side of the seatback rest 20, and allows the belt to be wound by the retractor at the rear side of the seat backrest 20, and the slip guide 220 serves to support and fix the belt.

Here, the slip guide 220 is fixed at one side of the shoulder portion of the seat backrest 20 by a fixing means, and has the case 222 having a hole 224 formed therein, and a guide shaft 226, which guides the belt 10, is provided in the hole 224 of the case 222.

Therefore, the belt 10, which is withdrawn from the retractor 110, mat be always operated at a constant position by the slip guide 220.

As described above, since the belt 10 is supported by the slip guide 220 installed at the position of the shoulder portion of the seat backrest 20, the belt 10 may be distant from the neck portion, thereby reducing a risk of accident.

However, there is concern that the belt 10 may press the chest and the abdomen because the slip guide 220 is installed at the position of the shoulder portion of the seat backrest 20, but because a shock absorbing member (a fibrous material having elasticity), which serves as a buffer, is included in the belt, the driver may drive the vehicle in a comfortable posture.

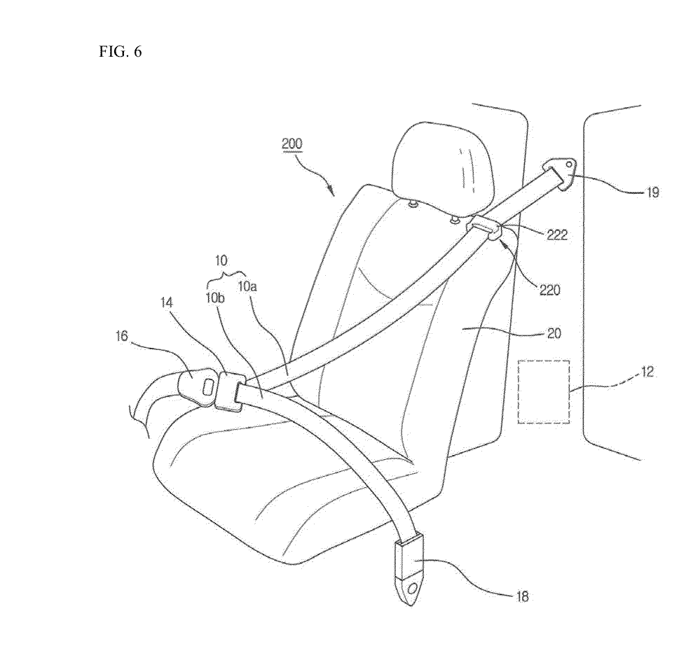

FIG. 6 is a perspective view illustrating a motor vehicle safety belt according to a third exemplary embodiment of the present invention.

As illustrated in FIG. 6, a motor vehicle safety belt 300 according to the third exemplary embodiment of the present invention includes a belt 10 which restricts a body of an occupant, a retractor 12 which is disposed at a door side of a vehicle body in a vehicle and winds up one end of the belt 10, a tongue plate 14 which is fastened to the other end of the belt 10, a buckle 16 which is installed at one side of a seat to fix the belt 10 and binds with the tongue plate 14 fixed to the belt 110, and an anchor 18 which fixes the other end of the belt 110 to the vehicle body.

In particular, the retractor 12 winds up one end of the belt 10 through a first slip guide 220 which is fixed at one side of a shoulder portion of a seat backrest 20 by a fixing means and guides the belt 10, and a second slip guide 19 which is positioned above the first slip guide 220 and installed at the door side of the vehicle body of the vehicle.

As described above, in the third exemplary embodiment, the belt 10 is wound by the retractor 12 through the two guides including the first and second slip guides 220 and 19. In this case, since a shoulder belt 10a is fixed at the position of the shoulder portion of the seat backrest 20 by the first slip guide 220, the shoulder belt keeps a predetermined distance from a neck portion of the occupant and is distant from the neck portion, and as a result, there is no possibility that the shoulder belt 10a will strike the neck portion. In addition, there is concern that the belt 10 may press the chest and the abdomen because the first slip guide 220 is installed at the position of the shoulder portion of the seat backrest 20, but because a shock absorbing member (a fibrous material having elasticity), which serves as a buffer, is included in the belt, the driver may drive the vehicle in a comfortable posture. In addition, a process of winding the belt 10 with two steps through the second slip guide 220 may serve as a buffer.

While the exemplary embodiments of the motor vehicle safety belt according to the present invention have been described above, the present invention is not limited thereto, but may be applied to the safety belt that is typically installed in the vehicle, and may be implemented by being modified in various forms within the scope of the claims, the detailed description of the invention, and the accompanying drawings, and the modification also belongs to the scope of the present invention.

### INDUSTRIAL APPLICABILITY

The present invention relates to a motor vehicle safety belt which is configured to allow a shoulder belt to be distant from a neck portion of an occupant when a body of the occupant leans toward a side due to a traffic accident, thereby preventing an accident in which the shoulder belt strikes the neck portion, and the present invention is industrially applicable.

1. A motor vehicle safety belt comprising:
a belt which includes a shoulder belt, and a waist belt, and restricts a body of an occupant;
a retractor which is installed at a door side of a vehicle body, and winds up one end of the belt;
a tongue plate which is fastened to the belt;
a buckle which is installed at one side of a seat, in which the occupant is seated, fixes the belt, and binds with the tongue plate; and
an anchor which fixes the other end of the belt to the vehicle body,
wherein a belt strap is added at a side opposite to a vertex where the shoulder belt and the waist belt are coupled, so as to form a Δ shape between the shoulder belt and the waist belt.

2. The motor vehicle safety belt of claim 1, wherein any one of one end of the shoulder belt coupled to the belt strap and one end of the waist belt coupled to the belt strap is configured with an attachment configuration using a Velcro tape.

3. The motor vehicle safety belt of claim 1, wherein both one end of the shoulder belt coupled to the belt strap and the other end of the waist belt coupled to the belt strap are configured with attachment configurations using a Velcro tape.

4. The motor vehicle safety belt of claim 1, wherein installation positions of the anchor and the retractor are switched, and the belt having the Δ shape is wound by the retractor.

5. A motor vehicle safety belt comprising:
a belt which restricts a body of an occupant;
a retractor which winds up one end of the belt;
a tongue plate which is fastened to the other end of the belt;
a buckle which is installed at one side of a seat in which the occupant is seated, fixes the belt, and binds with the tongue plate fixed to the belt;
an anchor which fixes the other end of the belt to a vehicle body; and
a slip guide which is fixed at one side of a shoulder portion of a seat backrest by a fixing means,
wherein the retractor is installed at a rear side of the seat backrest, and the belt is guided to the retractor by the slip guide.

6. The motor vehicle safety belt of claim 5, wherein an installation hole having a predetermined depth is formed at the rear side of the seat backrest, the retractor is installed in the installation hole, a hinge shaft is provided at an upper end inside the installation hole, and the retractor is rotatably fastened and fixed to the hinge shaft.

7. The motor vehicle safety belt of claim 6, comprising:
a movement prevention member which is fixed to the hinge shaft, and prevents the retractor from being moved leftward and rightward on the hinge shaft.

8. The motor vehicle safety belt of claim 6, comprising:
a guide groove which is formed in a diagonal direction, which is symmetric with a direction in which the belt surrounds the occupant, so as to be associated with the installation hole, and guides the belt, which is withdrawn from the retractor, to the slip guide.

9. The motor vehicle safety belt of claim 6, comprising:
a cover member which covers the rear side of the seat backrest, and covers the installation hole and the guide groove.

10. The motor vehicle safety belt of claim 5, wherein the belt has a shock absorbing member.

11. A motor vehicle safety belt comprising:
a belt which restricts a body of an occupant;
a retractor which is disposed at a door side of a vehicle body in a vehicle, and winds up one end of the belt;
a tongue plate which is fastened to the other end of the belt;
a buckle which is installed at one side of a seat in which the occupant is seated, fixes the belt, and binds with the tongue plate fixed to the belt;
an anchor which fixes the other end of the belt to a vehicle body;
a first slip guide which is fixed at one side of a shoulder portion of a seat backrest by a fixing means; and
a second slip guide which is positioned above the first slip guide, and installed on the door side of the vehicle body,
wherein the belt is guided to the retractor by the first slip guide and the second slip guide.

12. The motor vehicle safety belt of claim 11, wherein the belt has a shock absorbing member.
